(19) United States
(12) Patent Application Publication
(10) Pub. No.: US 2001/0015117 A1
(43) Pub. Date: Aug. 23, 2001

(54) Universal machine tool

(76) Inventor: Gerd Hoppe, Habichtswald (DE)

Correspondence Address: THE MAXHAM FIRM, 750 "B" STREET, SUITE 3100, SAN DIEGO, CA, 92101, US

(21) Appl. No.: 09/784,681

(22) Filed: Feb. 15, 2001

(30) Foreign Application Priority Data
Feb. 16, 2000 (DE) 100 06 897.9

(51) Int. Cl. B23B 3/00; B23B 27/00

(52) U.S. Cl. 82/117; 82/162

(57) ABSTRACT

A universal machine tool having a machine tool column shiftable on a machine bed along a first horizontal axis by means of a motor, and a tool slide shiftable on the machine tool column along a vertical axis, also by means of motor. The machine tool has a rotatably driven work spindle, and a workpiece slide shiftable on the machine bed along a second horizontal axis perpendicular to the first horizontal axis and comprising a workpiece table for the workpieces to be machined. For enabling multi-axis machining with a single mounting operation and a facilitated chip removal, the workpiece table is arranged on the workpiece slide so as to be pivotable between a horizontal and a vertical position.

### BACKGROUND

1. Field of the Invention

The invention relates in general to universal machine tools, and more particularly to such an apparatus having a machine tool column shiftable on a machine bed, a tool slide shiftable on the tool column and having a rotatably driven work spindle, and workpiece handling apparatus to facilitate accurate multi-axis machining of workpieces with a single mounting operation, and including simplified chip removal.

2. Background Discussion

Universal machine tools of this general type are known, for example, from EP 0 664 176. The universal milling and drilling machine disclosed therein comprises a machine bed on the front portion of which a workpiece slide provided with a horizontal workpiece table is horizontally movable in the longitudinal direction of the machine bed. On the rear part of the machine bed a movable column is supported and guided so as to be movable transverse to the moving direction of the workpiece slide by means of a motor. On the front side of the movable column a vertically movable support housing comprising a milling head pivotable between a horizontal and a vertical position is disposed. With a machine tool designed in this manner even complex machining operations can be carried out on a plurality of sides of a workpiece. There arises, however, the problem of a possibly complicated chip removal since, for example, the chips remaining on the horizontal workpiece table have to be removed manually.

### SUMMARY OF THE INVENTION

It is a primary purpose of the invention to provide a universal machine tool of the type mentioned above to enable accurate multi-axis machining of even large and bulky workpieces with a single mounting operation, as well as providing simplified chip removal. According to the invention, that purpose is solved by providing the workpiece table on the workpiece slide so that it is pivotable between horizontal and vertical positions.

The universal machine tool according to the invention offers the possibility to mount the workpieces on the workpiece table so that they are machined in a vertical position of the workpiece table. During this kind of machining the generated chips can freely fall down, for example, into a chip receiving space provided in the machine bed for this purpose. From there they may than be transported to a separate chip container or the like by a conveyor worm or another appropriate conveyor means. Thereby the chip removal can be considerably facilitated. Another important advantage of this machine concept resides in the stiff machine construction enabling a highly accurate machining even of larger and heavier workpieces. This is realized by supporting the workpiece table on the stable and dimensionally rigid machine bed in the frontal as well as the vertical position.

In a particularly robust and rigid embodiment the workpiece slide is provided with a support part formed, for example, in the shape of a triangular prism shiftably guided on guides and comprising a support surface extending obliquely downward at about 45° with respect to a vertical side wall of the machine tool column. A console supporting the workpiece table is disposed on the support part so as to be turnable about a central axis perpendicular to the contact surface by means of a motor. Thereby the forces acting on the workpiece during machining as well as the gravitational forces in the vertical, horizontal, or any intermediate position of the tool table, are optimally received by the dimensionally stable machine bed through the stable support part. The workpiece table can rapidly be turned to a vertical position or to any intermediate position from a horizontal position by the console which is turnable by means of a motor.

In a particularly efficacious embodiment telescope covers, for example in the shape of cover sheets shiftable against each other, extending obliquely downward toward a chip receiving space in the machine tool column, are disposed on the sides of the tool slide. The chips dropping onto the cover can slide from these covers and will thus enter the chip receiving space in the machine tool column together with possibly used coolant-lubricants.

A particularly good accessibility of the machining area of the machine tool is obtained in an advantageous embodiment by providing the machine bed with an indentation in the shape of an arc of a circle on the front side. The machine tool is efficaciously provided with a protective cabin comprising a laterally shiftable round door in the area of the indentation. Thereby the accessibility of the workpiece table is considerably facilitated.

### BRIEF DESCRIPTION OF THE DRAWING

Further particularities, advantages, features and benefits of the invention will be more readily understood from the following detailed description, when read in conjunction with the accompanying drawing, in which:

FIG. 1 is a schematic perspective view the basic design of a universal machine tool according to the invention; and

FIG. 2 is a perspective view of the FIG. 1 universal machine tool and having a protective cabin.

### DETAILED DESCRIPTION OF THE PREFERRED EMBODIMENTS

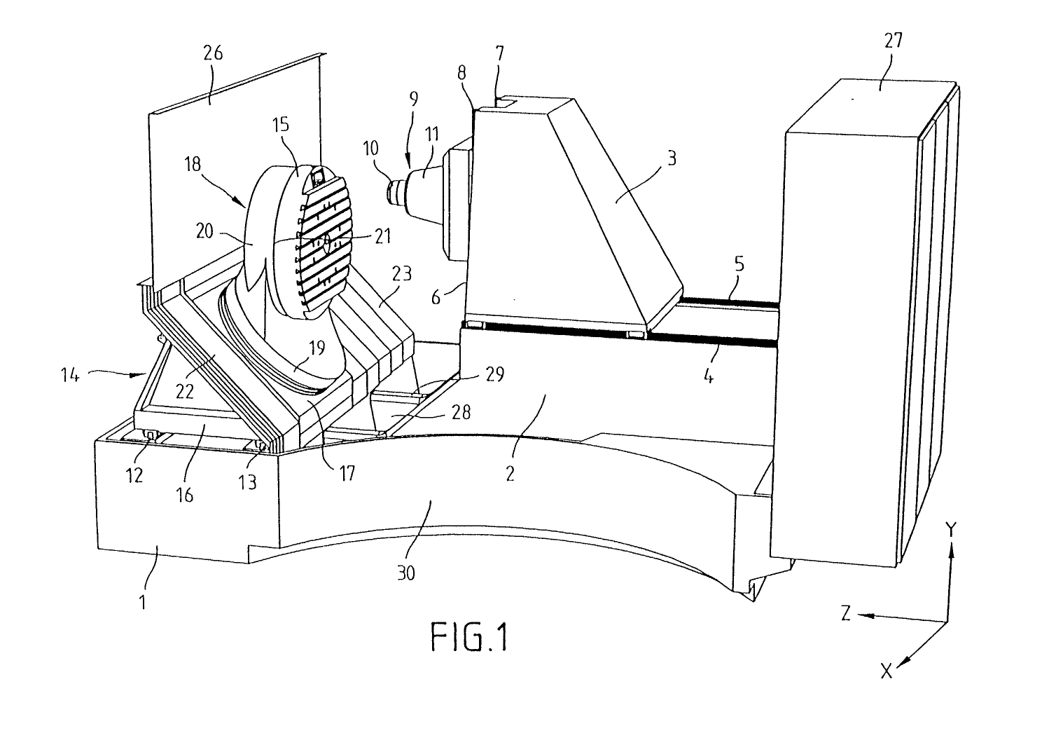

The universal milling and drilling machine shown in FIG. 1 is provided with a dimensionally stable machine bed 1 formed as a moulded part or it may be a welded construction, and comprising raised bed body 2 on which vertical machine tool column 3, formed as a movable column, is shiftable by means of a drive (not shown) along a first horizontal axis (Z-axis) on two parallel guide tracks 4 and 5 disposed on the upper side of bed body 2.

On left vertical side wall 6 of dimensionally stable machine tool column 3, which is formed, for example, as a moulded construction or ribbed welded construction, two vertically extending parallel guide tracks 7 and 8 are mounted on which tool slide 9, comprising horizontal work spindle 10, is disposed so as to be shiftable along a vertical axis (Y-axis) by means of a drive (not shown). Work spindle 10 is rotatably borne in support housing 11 of tool slide 9 and is driven by a speed-controlled motor (not shown). In the embodiment shown in FIG. 1 work spindle 9 is formed as a motor-driven spindle.

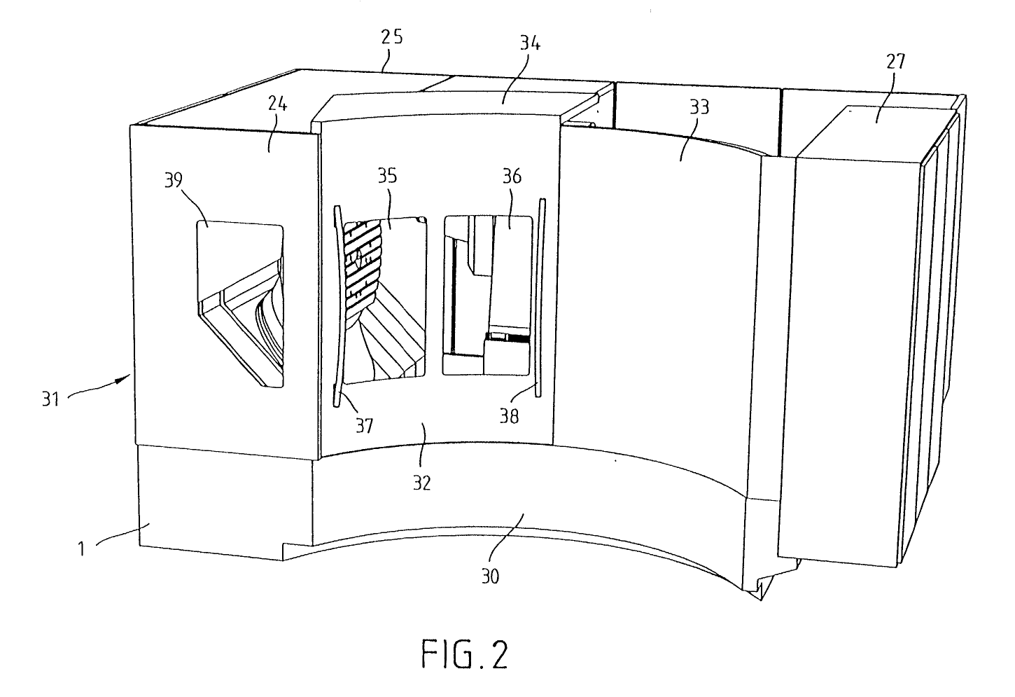

On the left side of machine bed 1 two horizontal guide tracks 12 and 13, extending at an angle of 90° with respect to guide tracks 4 and 5, are disposed at a distance from bed body 2. Workpiece slide 14, comprising workpiece table 15 pivotable between horizontal and vertical positions, is shiftable along a second horizontal axis (X-axis) perpendicular to the first horizontal axis on guide tracks 12 and 13 by means of a drive (not shown). Workpiece slide 14 includes support part 16 in the shape of a triangular prism shiftably guided on guide tracks 12 and 13 and having support surface 17 inclined at an angle of 45° with respect to vertical side wall 6 of machine tool column 3. On support surface 17 console 18 is disposed so as to be rotatable about a central axis perpendicular to the support surface by means of a drive (not shown). The console comprises pedestal 19 positioned on the support surface, and support shoulder 20 integrally formed with the pedestal and including support surface 21 disposed at 45° with respect to the rotational axis of the console in the embodiment illustrated in FIGS. 1 and 2. On support surface 21 workpiece table 15 is mounted which is a round table that can be turned about a central axis perpendicular to the support surface by means of a motor in the illustrated embodiment. By a corresponding rotation of console 18 about its rotational axis workpiece table 15 is thus turnable between the vertical position shown in FIG. 1 and a horizontal position (not shown). The central axis of the workpiece table always intersects the rotational and central axis of console 18 in one point independently from the rotational position of the console or the workpiece table. For turning console 18 and workpiece table 15, as well as for a linear movement of column 3, slide tool 9 and workpiece slide 14, conventional drives such as electric motors, or hydraulic motors with or without gearing, maybe used.

On the sides of support surface 17, one end of each telescopic cover 22, 23 of cover plates which are shiftable against each other, is disposed on workpiece slide 14. The other ends of telescopic covers 22, 23 are fixed to front and rear side walls 24 and 25 of protective cabin 31, as shown in FIG. 2. In this way the rear portion of workpiece table 14, and particularly its guide including guide tracks 12 or 13, are protected from contamination by machining chips or the like. At the upper end of support surface 17 additional lateral cover sheet 26 is disposed. At the right end of machine bed 1 control cabinet 27, for the accommodation of the control and supply devices, is fixed.

To enable a fast removal of chips, chip receiving space 28, separated by reinforcement 29, is provided in machine bed 1 between bed body 2 and workpiece slide 14. From there the chips can then be transported to a separate chip container or the like by appropriate means such as a conveyor worm (not shown). Machine bed 1 is provided with arc-shaped indentation 30 on the longitudinal face side, that indentation facilitating access to the work area.

As can be seen from FIG. 2, protective cabin 31 is fixed on machine bed 1 and is provided with laterally movable round door 32 in the area of indentation 30. The round door extends substantially over the left half of indentation 30 in the closed position. The right half is covered by curved solid wall panel 33. Round door 32 is provided with a cover plate perpendicularly bent to the inside on its upper side and is shiftably guided on the upper side of the protective cabin or on the machine bed, or both, by corresponding guides. In the fully opened position round door 32 overlaps wall part 33 and thus enables good access to the work area of the machine tool. In the embodiment shown two windows 35 and 36 and handles 37 or 38 are provided on the two sides of round door 32. For a better visibility of the work area an additional window 39 is provided in front side wall 24 of the cabin as well. With the indentation and the shiftable lateral door a particularly good access to the work area of the machine is enabled, whereby mounting of the workpieces or their observation is considerably facilitated.

The machine tool according to the invention comprises, in addition to the components described above, also per se known and therefore not shown, tool stores and a corresponding tool exchange means, for example, in the shape of a gripper arrangement including one or more tool grippers. In this way workpieces may be completely machined without any manual intervention. With a controlled linear movement of machine tool column 3, tool slide 9 and workpiece slide 14, as well as by a rotational movement of console 18 and workpiece table 15, machining in five axes, even of workpieces having a complicated form, is possible with one mounting operation.

The invention is not limited to the embodiment described in detail and illustrated in the drawing. The workpiece table may, for example, also be provided with a corresponding drive by which the workpiece table is driven with a corresponding speed. With the aid of turning tools inserted into the work spindle different turning operations may also be carried out with a corresponding drive of turntable 15.

What is claimed is:

1. A universal machine tool having a machine bed and a bed body comprising a machine tool column movable on the machine bed along a first horizontal axis;
a tool slide movable on said machine tool column along a vertical axis, said tool slide having a rotatably driven work spindle; and
a workpiece slide shiftable on the machine bed along a second horizontal axis perpendicular to the first horizontal axis, said workpiece slide having a workpiece table for holding the workpieces to be machined;
wherein said workpiece table is disposed on said workpiece slide so as to be pivotable between a horizontal position and a vertical position.

2. The universal machine tool according to claim 1, wherein said workpiece slide comprises:
a support part movable on guides mounted on said machine bed;
a support surface extending obliquely downward at 45° with respect to a vertical side wall of said machine tool column; and
a console supporting said workpiece table being disposed on said support surface so as to be turnable about a central axis perpendicular to said support surface.

3. The universal machine tool according to claim 2, wherein said console comprises a pedestal disposed on said support surface and a support shoulder integrally formed with said pedestal, said support shoulder being provided with a support surface for said workpiece table extending in an angle of 45° with respect to the rotational axis of said console.

4. The universal machine tool according to claim 2 or 3, wherein said support part has the shape of a triangular prism.

5. The universal machine tool according to one of claims 1 to 3, and further comprising telescopic covers extending obliquely downward toward a chip receiving space in the machine tool column, said covers are disposed on the sides of said workpiece slide.

6. The universal machine tool according to claim 5, wherein said chip receiving space is disposed between the bed body for guiding said machine tool column and said workpiece slide.

7. The universal machine tool according to one of claims 1 to 3, wherein said machine bed is formed with an arc-shaped indentation in one of its longitudinal sides.

8. The universal machine tool according to one of claims 1 to 3, and further comprising a protective cabin disposed on said machine bed.

9. The universal machine tool according to claim 5, and further comprising a protective cabin disposed on said machine bed.

10. The universal machine tool according to claim 6, and further comprising a protective cabin disposed on said machine bed.

11. The universal machine tool according to claim 7, and further comprising a protective cabin disposed on said machine bed.

12. The universal machine tool according to claim 7, and further comprising a protective cabin having a laterally shiftable round door generally adjacent to said indentation.

13. The universal machine tool according to claim 1 or 2, wherein said workpiece table is round and is revolvable about its central axis.
